(19) United States
(12) Patent Application Publication
(10) Pub. No.: US 2020/0270110 A1
(43) Pub. Date: Aug. 27, 2020

(54) DEVICE AND METHOD FOR ENSURING AN INTERNAL CONTAINER PRESSURE BY APPLICATION OF PRESSURE MULTIPLE TIMES TO THE HEAD SPACE

(71) Applicant: KRONES AG, Neutraubling (DE)

(72) Inventors: Jochen HIRDINA, Regensburg (DE); Ludovic LAINE, Hainsacker (DE)

(21) Appl. No.: 16/797,936

(22) Filed: Feb. 21, 2020

(30) Foreign Application Priority Data
Feb. 21, 2019 (DE) 10 2019 104 365.4

(51) Int. Cl. B67C 3/26; B67C 7/00; B67C 3/22

(52) U.S. Cl. CPC B67C 3/26; B67C 7/0046; B67C 2003/227; B67C 2007/006; B67C 3/225

(57) ABSTRACT

Disclosed is a device and a method for filling and closing a thin-walled plastic container, in particular a PET bottle, wherein a plastic container is produced from a preform by a blow moulding process, and the plastic container is filled with a flowable medium and in particular a liquid, and also a replacement medium is introduced into the plastic container so that as the internal container pressure increases at least partial displacement of the previously contained medium takes place and the plastic container is at least partially closed, plastic container, a wall of the container closure or between a wall of the plastic container and a wall of the container closure at least one opening is introduced, and through this opening in the interior space of the plastic container a predetermined internal container pressure is set by feeding in and/or discharging a gaseous medium.

The present invention relates to a device and a method for ensuring an internal container pressure by application of pressure multiple times to the head space of a container.

From the prior art is known that it may be advantageous to displace the air contained in the head space of a beverage container, for example by introduction of liquid or gaseous nitrogen. In particular, the enormous volume expansion of liquid nitrogen during the transition thereof into the gaseous phase upon contact with the filling material which is at a temperature significantly above the boiling point of the nitrogen can be used for displacing air (air oxygen). As a result, a better shelf life of the filling material, such as for example a beverage, can be achieved.

Furthermore, it is known from EP 2 226 179 A1 that the introduction of nitrogen into the head space of a container can be used to prevent or at least to reduce the shrinkage of containers after the cooling of the hot liquid filling material which is introduced. However, this presupposes a special control of the container temperature and in particular the setting of a reduced temperature of the container base. Likewise, a particularly stable base geometry is necessary in order to ensure the required stability. The method is nevertheless limited to substantially cylindrical bottle geometries.

During introduction of liquid nitrogen into the top region the enormous increase in volume thereof from approximately 1.24 Vkg to approximately 0.8 m³/kg (at 273.15 K) during transition into the gaseous phase takes place extremely quickly. The smallest variations in the process, such as for example changed ambient temperature, changed filling material temperature, volume fluctuations of the head space volume, volume fluctuations of the introduced liquid nitrogen and the time between introduction of the liquid nitrogen and the closure of the container, therefore have an enormous influence on the resulting internal container pressure. Whilst a slight internal container pressure of for example 1.1-2 bars is usually required, since by comparison with an internal container pressure which is too low simplifies the further handling of the container, for example the gripping, labelling and stacking, an internal container pressure which is too high can cause bursting of the container.

Therefore, the object of the present invention is to provide a device and a method which eliminates the disadvantages known from the prior art.

With regard to the method this object is achieved by the method according to claim 1. With regard to the device this object is achieved by the device according to claim 7.

Thus a significant aspect of the invention is a method for filling and closing a thin-walled plastic container, in particular a PET bottle, wherein a plastic container is produced from a preform by a blow moulding process, and the plastic container is filled with a flowable medium and in particular a liquid, and also a replacement medium is introduced into the plastic container so that as the internal container pressure increases at least partial displacement of the previously contained medium takes place and the plastic container is at least partially closed.

Furthermore, according to the invention it is provided that in at least one portion of a wall of the plastic container surrounding a head space of the plastic container, a wall of the container closure or between a wall of the plastic container and a wall of the container closure, at least one opening is introduced, and through this opening or via an interior space of the plastic container a predetermined internal container pressure is set by feeding in and/or discharging a gaseous medium.

In particular in this case, a method is preferred in which the plastic container is initially filled with a flowable medium and in which in a further step a replacement medium is introduced into the plastic container.

Thus, a preferred method according to the invention is a method for filling and closing a thin-walled plastic container, in particular a PET bottle, comprising the steps:
a) producing a plastic container from a preform by a blow moulding process;
b) filling the plastic container with a flowable medium, and in particular with a liquid;
c) replacement or displacement of the medium contained in the head space of the filled plastic container by introduction of a replacement medium as the internal container pressure increases and
d) subsequently, at least partial closing of the plastic container.

Furthermore, with regard to the method it is provided that in at least one portion of a wall of the plastic container surrounding the head space of the container, a wall of the container closure or between a wall of the plastic container and a wall of the container closure at least one opening is introduced, and through this opening in the interior space of the plastic container a predetermined internal container pressure is set by feeding in and/or discharging a gaseous medium.

This method offers the possibility, after the filling of the container, of replacing the medium contained in the head space of the container and thus protecting the filling material for example from oxygen or contamination by foreign bodies and/or bacteria. Furthermore, by the introduction of the replacement medium with a positive pressure it can be ensured that, after the closing of the container, because of the increased internal pressure the container can withstand pressures acting on it from the exterior, such as for example the pressure of gripping elements or the pressure during stacking of containers.

Furthermore, the method offers the possibility of setting the pressure in step e) more precisely. If for example in step c) the medium previously located in the head space is expelled by the introduction of liquid nitrogen, the resulting internal container pressure can be influenced by many factors which make the setting of a defined internal container pressure difficult. Because of the enormous increase in volume during the transition into the gas phase, small changes in the introduced volume of the liquid nitrogen can already give rise to very great effects on the resulting internal container pressure. Moreover, for example due to the shortened time necessary for complete evaporation, and the time between introduction of the replacement medium and the closing, the temperature of the filling material inter alia can have an influence on the resulting internal container pressure. Thus, the resulting internal container pressure could be too low or—for example due to larger quantities of nitrogen evaporating only after the closing—could be so high that there is a danger of the container bursting. Likewise it is conceivable, that with an increased pressure a supersaturation of liquid filling material occurs on the gaseous replacement medium and this escapes abruptly upon opening of the container with formation of foam and/or expulsion of the filling material. This problem can be eliminated by the setting of a predetermined internal container pressure in step e). The feeding and/or discharge of a gaseous medium makes it possible to adapt the previously set internal container pressure to the requirements of the following container processing steps and thus for example to ensure the reliable transport and/or the stackability and to prevent the bursting due to excessively high internal container pressure.

The flowable medium is advantageously a beverage, which more preferably is heated.

In another variant of the method it would preferably also be conceivable that first of all a replacement medium is introduced into the plastic container and the plastic container is filled with the flowable medium after the introduction of the replacement medium.

Accordingly, the method according to the invention is also a method for filling and closing a thin-walled plastic container, in particular a PET bottle, comprising the steps:
a) producing a plastic container from a preform by a blow moulding process;
b) introducing a replacement medium into the plastic container,
c) filling the plastic container with a flowable medium, and in particular with a liquid, so that the replacement medium contained in the plastic container is displaced as the internal container pressure increases; and
d) subsequently, at least partial closing of the plastic container. Furthermore, with regard to the method it is provided that in at least one portion of a wall of the plastic container surrounding the head space of the container, of a wall of the container closure or between a wall of the plastic container and a wall of the container closure at least one opening is introduced, and in a step e) through this opening in the interior space of the plastic container a predetermined internal container pressure is set by feeding in and/or discharging a gaseous medium.

In this case the container is preferably flushed with the replacement medium before filling with the flowable medium.

Furthermore, however, it would also be conceivable that in a further advantageous variant of the method first of all a replacement medium is introduced into the plastic container, then the plastic container is filled with the flowable medium and adjoin then setting the internal container pressure a gaseous medium is introduced into the plastic container or removed therefrom, wherein the container is closed during and/or after this setting of the internal container pressure.

Accordingly, the method according to the invention is also a method for filling and closing a thin-walled plastic container, in particular a PET bottle, comprising the steps:
a) producing a plastic container from a preform by a blow moulding process;
b) introducing a replacement medium into the plastic container;
c) filing the plastic container with a flowable medium, and in particular with a liquid, so that the replacement medium contained in the plastic container is displaced as the internal container pressure increases;
d) setting of a predetermined internal container pressure by introducing or discharging a gaseous medium into or out of the plastic container,
e) wherein the plastic container is at least partially closed at least temporarily during the setting of the predetermined internal container pressure.

The gaseous medium is preferably nitrogen. Particularly preferably the gaseous medium and in particular the nitrogen is introduced into the plastic container just before the container is closed. For this purpose, an introducing device, such as for example a nozzle, is preferably arranged laterally alongside the mouth of the plastic container, and continuously sprays nitrogen in the direction of the mouth. In this case the plastic container is particularly preferably closed at least temporarily during the spraying with the nitrogen.

In a preferred variant of the method the replacement medium is nitrogen, preferably liquid nitrogen. Nitrogen is chemically largely inert. Thus, reactions with the filling material are largely ruled out. Moreover, the solubility of nitrogen in aqueous solutions is limited. Therefore—at least with a known filling level—the required amount of the nitrogen for driving out the medium (for example air) previously located in the head space can be determined very precisely. Nitrogen is gaseous at room temperature, so that high flow velocities can be achieved, which is advantageous for the complete expulsion of the medium previously located in the head space. The use of liquid nitrogen has been found to be particularly advantageous. In this case the feeding of the replacement medium and in particular of the nitrogen can take place continuously or preferably not continuously, through for example a so-called droppler.

In particular, therefore, a variant of the method is preferred in which the production of the raised internal container pressure takes place by the increase in volume of the nitrogen during the transition from the liquid phase into the gaseous phase. Almost regardless of the conventional temperature of the filling material, there is actually a high temperature difference between liquid nitrogen, which at normal pressure has a boiling point of 77.15 K or −196° C., and the preferably aqueous filling material, which usually has temperatures between 268 K (−5° C., also at temperatures below 0° C. aqueous solutions can be flowable due to the dissolved substances, which in particular in the case of sensitive substances such as medicaments makes liquid bottling below 0° C. possible) and 383 K (110° C.), in such a way that the nitrogen abruptly changes its physical state and transitions into the gaseous phase. Since in this case the temperature difference between liquid nitrogen and filling material is always at least 150° C., the influence of different filling material temperatures on the speed of change of the physical state of the nitrogen is of lesser significance for the complete expulsion of the medium previously located in the head space. The speed of the transition into the gaseous phase is influenced substantially by a gas cushion which forms between the filling material and the liquid nitrogen and serves as thermal insulation between the liquid nitrogen and the filling material. However, since the gas escapes from the gas cushion, this involves a dynamic and volatile insulation, which is continuously newly formed by the changing physical state of the nitrogen until no more liquid nitrogen remains. The delay in the change of the physical state achieved in this way makes it possible before the complete transition of the nitrogen into the gaseous phase to close the container and thus to establishing a positive pressure in the interior of the container.

In a preferred variant of the method the flowable medium (in particular at the time of the transfer into the plastic container) has a temperature above the ambient temperature, preferably in the range from 40-110° C., more preferably in the range from 50-100° C. particularly preferably in the range from 60-90° C. In particular, in the case of filling material, which is introduced at a raised temperature, a raised internal container pressure has proved advantageous, since in this way it is possible to compensate for the loss of volume occurring during cooling of the filling material volume. Furthermore, in particular products which are to be introduced while hot are often sterile and must be protected against contamination with foreign substances. The present method offers the possibility here of preventing the inflow of foreign substances into the interior of the container by the production of a positive pressure in the interior of the container. Thus in the case of filling materials to be protected in such a way the present method offers the possibility, alongside the provision of the compensating volume for the temperature-dependent density change (and thus the change in volume resulting therefrom) of the filling material, of also preventing the contamination, for example by bacteria.

In particular, if the filling material has a temperature above the ambient temperature, it is advantageous if during and/or after a process, preferably active cooling of the filling material, the setting of the predetermined internal container pressure takes place by feeding in and/or discharging the gaseous medium. In particular in the case of filling materials which must be protected against contamination, it is important that also during the decrease in volume occurring due to the cooling no internal container pressure ever prevails which is below the ambient pressure. This could not only lead to the deformation of the container, but because of the medium flowing in it could cause the contamination of the filling material, for example by introducing bacteria. Likewise, it would be conceivable for air and thus oxygen to flow in, which could react with substances of the filling material and for example could render flavourings and/or colourings inactive due to the oxidation thereof. In order to ensure that the internal container pressure which is raised relative to the environment remains so even after the cooling of the filing material, it is advantageous that the setting of the predetermined internal container pressure takes place by feeding in and/or discharging the gaseous medium at least also proportionately after the end of the cooling. In this context “after the cooling has ended” should not be understood to mean that no further cooling could take place, but the cooling should already be completed to such an extent that even in the event of further cooling it is ensured that the decrease in volume of the filling material due to this further cooling remains within such a small range that this can be compensated for by the internal container pressure being set in the container while maintaining a lower internal container pressure which is nevertheless still raised relative to the environment.

In a further preferred variant of the method the setting of the predetermined internal container pressure is carried out by feeding in and/or discharging the gaseous medium during and after the cooling of the filling material. Thus during the cooling it can be ensured that a minimum internal container pressure is not reached and also after the cooling a defined internal container pressure can be set. In this case the setting of the predetermined internal container pressure can take place continuously or can be carried out multiple times by feeding in and/or discharging the gaseous medium. In particular in the case of fast cooling filling material, a possible solution is the continuous control and adaptation of the internal container pressure to a target pressure by feeding in or discharging the gaseous medium.

However, since the continuous control and adaptation of the pressure is complex with regard to apparatus, a possible solution is in many cases the intermittent control and/or adaptation of the internal container pressure. “Intermittent control and/or adaptation” of the internal container pressure is understood to mean any control and/or adaptation of the internal container pressure, in which at least control and/or adaptation of the internal container pressure takes place offset in terms of time and/or location relative to a preceding control and/or adaptation of the internal container pressure. In this case the accesses to the interior of the container for the respective control and/or adaptation of the internal container pressure may be different. Thus for example it would be conceivable to carry out a first adaptation of the internal container pressure via an intermediate space existing between a mouth and the container closure and to carry out a second control and/or adaptation of the internal container pressure via an opening introduced in a portion of a wall of the plastic container surrounding the head space of the container or a wall of the container closure.

In order to produce an intermediate space between a mouth and the container closure it would be possible that initially the container closure is not yet completely screwed onto the container, but first of all the gaseous medium is replaced via the said gap. The container closure is preferably a screw closure which is in particular screwed onto an external thread of the container.

“The container closure is not yet completely screwed onto the container” is preferably understood to mean that for instance a rotary closure is screwed to a certain extent onto a thread of the container but is not yet tightly closed. Advantageously, however, the container closure is already screwed firmly and thus in a sealing manner on the mouth of the container, which thus preferably corresponds to a complete sealing of the container with the container closure.

Advantageously the at least one opening provided in a portion of a wall of the plastic container surrounding the head space of the container or a wall of the container closure by piercing the said container wall or a wall of the container closure, for example with a needle-like body. Preferably this needle-like body or this needle can have a diameter which is less than 4 mm, preferably less than 3 mm, and particularly preferably less than 2 mm. In this case it is also possible that the needle itself is heated in order to pierce the vessel wall or the closure. In this way the material of the container can also be melted locally during the piercing.

Thus, it is possible that a temperature of the needle (at least in the portion which contacts the wall of the container) is more than 60° C., preferably more than 70° C., preferably greater than 80° C. and particularly preferably greater than 90° C.

In a further advantageous variant of this method the closure is opened slightly after the recooling (under defined environmental conditions, for example in a chamber), so that a communication connection between the environment and the interior of the container is produced. This can take place for example by slight turning of the closure. Thus an at least partial reduction of the positive pressure can take place. In this case this opening process can take place so that a tamper-evident strip does not tear off and the closure can be closed again normally.

Furthermore, in the event of intermittent control and/or adaptation of the internal container pressure, a possible solution is to provide one or more further instances of processing of the container between the instances of control and/or adaptation of the internal container pressure. For example, it is conceivable that by the first control and/or adaptation of the internal container pressure an internal container pressure is ensured, which facilitates the labeling of the container (for example by ensuring a sufficient container rigidity).

Furthermore, processing operations such as setting a predetermined pitch between successive containers on the transport path, sealing, grouping, placing in beverage crates or the like are conceivable. Thus, in the event of intermittent control and/or adaptation of the internal container pressure the internal container pressure after the respective adaptations may be different and may be tailored to the respectively following process steps. Thus, for example after the first control and/or adaptation of the internal container pressure a higher internal container pressure could prevail, which simplifies the labelling and only after a second control and/or adaptation of the internal container pressure the internal container pressure could be lowered further.

A variant of the method is preferred in which an internal container pressure is set which is in the range from 1.05-5 bars, preferably 1.05-2 bars, more preferably 1.1-1.5 bars, particularly preferably 1.1-1.5 bars, by the feeding in and/or discharge of a gaseous medium. These details relate in each case to the absolute pressure. There is preferably a pressure gradient between the interior of the container and the environment in the range from 0.05-4 bars, preferably in the range from 0.1-0.5 bar, particularly preferably in the range from 0.1-0.5 bar. In these ranges on the one hand a sufficiently high stability of the respective container is provided, in order to be able to handle it reliably handle and for example to label it. On the other hand, the internal container pressure is below a critical value, at which the container could burst or be deformed.

The method preferably offers the possibility of setting the internal container pressure so that no restrictions exist with regard to the container geometry. Thus, in the method it is also possible to process containers with oval or substantially rectangular cross-sections. Likewise, it is possible to process containers or special reinforcements of the container base according to the described method.

In a further advantageous method, the opening is closed after the setting of an internal container pressure by feeding in and/or discharge of a gaseous medium. This can take place for example by bonding or melting. In this case an ultrasound source may also be used for melting.

In a further preferred method, the containers are transported during the production thereof and/or during the bottling and/or during the feeding of the gaseous medium. Advantageously the containers are transported at least section by section along an arcuate path.

In a further preferred method, the containers are transported at least section by section through a clean room. This means that the method steps described here, in particular also the step of feeding or introducing or discharging the gaseous medium, take place under clean room conditions or under sterile conditions. In this case this clean room is preferably sealed or separated off by means of at least one wall relative to an (unsterile) environment. In a further preferred variant at least a portion of the wall is movable relative to another portion of the wall, wherein one of the wall portions at least partially follows the movement of the container along of the transport path.

In a further preferred method, the containers are sterilised. Thus, it is possible that the containers are sterilised directly after production thereof. However, it would also be possible that the plastic parisons are already sterilised before the transforming process to produce plastic bottles. Thus, it is also possible that the actual transforming process for transforming plastic parisons into plastic bottles already takes place under sterile conditions. In this case this sterilising can take place for example by means of a sterilising medium such as for instance hydrogen peroxide or peracetic acid, but also by means of radiation, for example electron radiation. However, it is pointed out that the sterilisation is an optional method step. This applies in particular in the case of those products in which the sterility is achieved by means of the heating of the liquid to be introduced.

In a further preferred method, the container wall is pierced in an upper half of the container and in particular an upper third of the container (or the opening is introduced at this point). In this case the term “the upper half” is relative to the longitudinal direction of the container which extends from a base of the container to the mouth of the container. Advantageously the container wall is pierced in an upper quarter, particularly preferably in an upper fifth relative to the longitudinal direction. Particularly preferably the piercing of the container wall takes place in a head or shoulder region of the container or in a region in the immediate proximity of a carrying ring of the container, for example below or above the said carrying ring. However, it would also be possible that the wall is pierced at a different location, for example the circumferential wall, for example when the containers are transported horizontally. An advantage of this method is that then the circumferential wall can be pierced, which as a rule is thinner than the wall in the region of the mouth of the container. For this purpose, a container turner can be used. In this case it would be possible that the container is rotated and preferably in this way the container closure (with the hot product) is sterilised.

In this case it is possible that a second container turner is provided which rotates the container again into the starting position. However, it would also be conceivable that the same container turner is run through twice.

In this embodiment a device is produced in which the container comes to lie horizontally and can be pierced on the side wall (and in particular in a region in which no liquid is located in the horizontal position).

The opening is preferably made in a region of the container in which, in the case of an upright container, no liquid is present at the time of penetration. In this way the liquid can be prevented from escaping through the opening.

In a further preferred method, the opening via which the gaseous medium has been fed to the container is closed or sealed again after the feeding in or discharge of the gaseous medium. In this case this closing or sealing of the opening can take place in a different way.

The term “sealing” is used hereafter. This sealing is advantageously carried out by means of a method which is selected from a group of methods which includes melting of a portion of the container wall, melting of a portion of a circumferential wall of the container closure, or a relative rotation of the container closure relative to the container.

Thus, it would also be possible that the needle which pierces the container wall is hot and subsequently closes the pierced region again. In addition, however, a discrete welding head could be provided which, after the retraction of the needle, is pressed onto the hole in order to close the opening again.

It would also be conceivable that an “external melting point” is applied which preferably consists of a material which differs from the material of the container wall.

In this case this sealing is possible during or after sealing of the container with the container closure.

Both the production of the opening and also the sealing of the opening preferably take place under clean room conditions and/or the intermediate space existing between a mouth and the container closure inside a clean room. These processes advantageously take place during a movement of the containers and, in particular during transport of the containers in their transport direction. In addition to or instead of the clean room a chamber can also be provided which, in particular surrounds the opening in the container wall and by means of which the gaseous medium is introduced into the container. In this case this chamber does not necessarily have to accommodate the entire container.

When such a chamber is used, on the one hand the “clean room” (which is formed by this chamber) can be reduced in size and on the other hand it can also be placed under a positive pressure, so that there is no need for a discrete gas feed device into the container, but the gas “automatically” enters the container after the penetration or partial opening.

In a further preferred method, closing or sealing of the container (or of the opening) is checked by means of an inspection device. Thus, for example an in particular visual inspection can be carried out to ascertain whether the said opening has been closed. This inspection preferably takes place contactlessly and particularly preferably visually.

A further significant aspect of the invention is a device for filling and sealing of a thin-walled plastic container, in particular a PET bottle. Such a device comprises a blow moulding device for producing a plastic container from a preform and a filling device for filling the plastic container with a flowable medium, and in particular with a liquid. Furthermore, a closer is provided for at least partially closing the plastic container with a container closure as well as at least one transport device for transporting the plastic container in a transport direction on a transport path from one of the above-mentioned processing devices to a subsequent processing device downstream. Moreover, it is significant for this device that on the transport path in the transport direction downstream and/or upstream of the filing device a replacement medium introduction device is arranged, by which a replacement medium can be introduced into the plastic container, wherein as a raised internal container pressure is produced the previously contained medium can be at least partially displaced.

Furthermore, on the transport path in the transport direction downstream or upstream of the closer, a device is preferably arranged, for example an internal container pressure setting device or an opening production device, by means of which through an opening which is arranged in at least one portion of a wall of the plastic container surrounding the head space of the container, or a wall of the container closure or is produced there, or via an intermediate space existing between a mouth of the plastic container and the container closure, in the interior space of the container a predetermined internal container pressure can be set by feeding in and/or discharging a gaseous medium. In this case this opening can be used for setting the internal container pressure.

Accordingly, also with regard to the device it is proposed to introduce a replacement medium into the plastic container by means of a replacement medium introduction device, wherein this takes place either before or after the filling of the plastic container with the flowable medium. Furthermore, an introduction of the gaseous medium for setting of the internal container pressure can preferably be performed before and/or during and/or after the closing of the container.

In a preferred embodiment, in this device the replacement medium introduction device is fluidically connected to a nitrogen reservoir from which nitrogen, preferably liquid nitrogen, can be dispensed and can be metered into the plastic container. Thus, in this embodiment the device is suitable and provided in order to be able to handle liquid nitrogen and to be able to dispense it in a precisely metered amount into the interior of the container. In this way a fast replacement of the gas located in the head space of the container can be achieved and—in with precise metering—the resulting internal container pressure can preferably be set at least in a predetermined range.

If the plastic container is initially filled with the flowable medium by means of the filling device, the nitrogen from the nitrogen reservoir can preferably be dispensed into the head space of the filled plastic container.

In a preferred embodiment of the device it is provided that the internal container pressure setting device has at least one valve which can be fluidically connected via the opening to the head space of the filled plastic container at least temporarily, is preferably regulable, and by means of which an internal pressure of the plastic container can be preselected. By means of such a valve the flow the replacement medium—preferably metered—can be controlled.

In a preferred embodiment of the device it is provided that on the transport path in the transport direction downstream of the replacement medium introduction device and upstream of the internal container pressure setting device a temperature control device, preferably a cooling device, is arranged, by means of which the plastic container, preferably including the contained flowable medium, can be brought to a target temperature in the range from 4-70° C., preferably 10-50° C., particularly preferably 20-30° C. The cooling of hot-filled filling material can be accelerated by such a cooling device and thus the change in volume of the filling material occurring during cooling can be accelerated. After passage through the temperature control device and the setting of the temperature of the flowable medium to the region specified above, the change in volume thereof in the event of further temperature change is as low as possible, so that the change in volume to be expected in this case can be compensated for by the positive pressure applied to the replacement medium in the container.

In a further advantageous embodiment, the temperature control device has nozzles by means of which a cooling medium, for example water, can be applied to the containers.

In a further advantageous embodiment, on the transport path in the transport direction downstream of a temperature control device and upstream of the internal container pressure setting device the device has a penetration device which is suitable and intended for piercing at least one portion of the wall of the container and/or at least one portion of the circumferential wall of the container closure.

In a further advantageous embodiment of the device a closing device is provided which is designed in such a way that it attaches the closure to the container in two steps, for instance it initially ensures with only a few turns that the closure is held on the container, but between the mouth thereof and the container closure an intermediate space is formed by which the gaseous medium can be fed in or discharged. The closing device could then be configured in order to fix the closure in a sealing manner on the container only at a later time.

In a further preferred embodiment of the device a closure handling device is provided is provided which, after the closing of the container, again carries out a slight opening thereof, for example by turning of the closure relative to the container, in order to form an intermediate space which is arranged between the mouth thereof and the container closure and through which the gaseous medium can be fed in or discharged.

In a further advantageous embodiment, the device has at least one sealing device which is suitable and intended for closing or sealing the opening through which the gaseous medium can be fed in or discharged. As mentioned above, this closing device is for example a fusion device which again fuses the portion of the container in which the opening has been made. However, it would also be possible that the closing device is the device which attaches the container closure to the container. Thus, first of all for example the bottle closer could screw a closure only partially onto the container or not yet close it completely. This closing process could only be completed in a subsequent step. In general, this operation could be carried out in the same closer which closes the containers with closures or also in a discrete device.

In a further advantageous embodiment, the device has a clean room, inside which the containers are transported at least intermittently. In this case this clean room can surround at least the region inside which the replacement medium and/or the gaseous medium is fed to the inward of the container or dispensed from the inward of the container. In this case it is possible that the clean room is formed by an upright housing, but it would also be possible that the clean room merely surrounds the transport path of the containers in the manner of a channel, wherein preferably at last one wall of the clean room is movable relative to at least one other wall of the clean room and at least partially follows the transport movement of the containers. It would also be possible that the transforming device also already transforms the plastic parisons into plastic bottles inside a clean room. In addition, it would also be possible that at least one chamber is provided, within which the gaseous medium is fed to the containers. This chamber could be configured for example as a holow cylinder in which the containers are located.

In a further advantageous embodiment, the penetration device and/or the replacement medium introduction device and/or the internal container pressure setting device is integrated into a region of the closer device which provides the containers with closures. Thus, this penetration device could for example be integrated into a gripping or holding device which holds the containers during the filling process. This gripping device could have a holding element which prevent a rotation of the plastic bottle with respect to its longitudinal direction. This element could be configured for example as a so-called spike plate which absorbs the closer torque.

In a further advantageous embodiment the internal container pressure setting device has a pressure control device and/or a pressure regulation device which is suitable and intended for controlling and/or regulating the pressure by means of which the gaseous medium is introduced into the containers or discharged therefrom. Thus, for example a sensor device could be provided, which is suitable and intended for determining the respective pressure of the gas inside the container and/or the pressure with which the gas is fed to the container. Thus in terms of apparatus a control and/or regulating device is provided, which controls and/or regulates the pressure by means of which the gas is fed to the container and/or the pressure under which the gas is then located in the container.

It is pointed out that this pressure regulation device can be used in all methods and devices described here, that is to say also in variants in which no penetration of the containers takes place in the closing device or which operate without penetration.

Preferably with regard to the device it is provided that the transport path runs along a segment of a circle at least in the region of the replacement medium introduction device. A closer arranged, which closes the container at least partially is preferably also arranged in this segment of a circle. More preferably the segment of a circle on which the closing takes place during the transport of the container is larger than in plants known from the prior art. This makes it possible that both the closing of the containers by the container closures and also the feeding of the replacement medium into the container can be carried out on the same segment of a circle. More preferably these two processes can be carried out substantially concurrently. Thus, overall a more compact possible embodiment of the device is produced, since in this way it is possible to dispense with two separate apparatus parts, specifically the replacement medium introduction device and the closer.

However, it is pointed out that the embodiment described here with the replacement medium introduction device in the region of the closer is not absolutely necessary. It is also possible that the replacement medium introduction device is arranged downstream of the closer and the replacement medium for example after a (partial) opening of the container closure or a piercing of a wall of the container or the closure thereof in a later treatment step, for example in a dedicated unit. For example, the replacement medium introduction device could be arranged on a transport path which lies between the closer and a further device, such as for instance a temperature control device.

In a preferred embodiment of the device the internal container pressure setting device comprises a chamber which at least partially surrounds the container. More preferably it is provided that inside this chamber a predetermined pressure prevails and this pressure is transmitted into the interior space in the container through the opening in the wall of the plastic container or of the container closure or via an intermediate space between the mouth of the plastic container and the container closure. In this case it is advantageous if the opening or the intermediate space are produced in the said chamber. It has proved particularly advantageous if penetration means are arranged in the region of the chamber. Optical penetration means, such as for example lasers, have proved particularly suitable. Thus, for example a hole can be welded into the container wall by means of a laser inside the chamber, which offers the advantage that it is possible to dispense with mechanical elements such as the above-mentioned needles. The sealing of the opening could possibly also be carried out by means of a laser. Thus, it is possible that inside this chamber the orifice is welded in by means of a laser and then the correct pressure is set. Furthermore, this procedure has the advantage of a high level of hygiene, since no mechanical components engage on the container.

In a further preferred embodiment of the device it is provided that the introduction of the opening into a wall of the container takes place in the side wall or in the base. For this purpose, the device preferably has a tilting device which tilts the already filled container.

In this case it is preferable that the container is tilted by approximately 90°, and for example is brought into a horizontal position, so that the piercing can take place in the side wall. With a piercing in the side wall a penetration in the region of the later labeling region is particularly advantageous, since any visual detriment can already be concealed by a label.

A penetration in the base region of the container is also conceivable, for example in the injection point. In this region the container is substantially unstretched and thus amorphous. This applies, in particular in the case of a production process for stretch blow moulded containers, such as PET containers. In addition, a relatively large amount of material is available in the region of the injection point, in order then to fuse the opening again.

Further advantages and embodiments are disclosed by the appended drawings.

In the drawings:

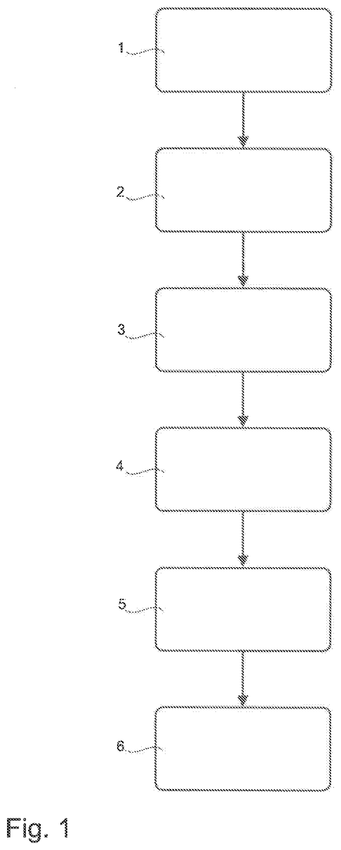

FIG. 1 shows a schematic representation of the methods for ensuring an internal container pressure through application of pressure multiple times to the head space;

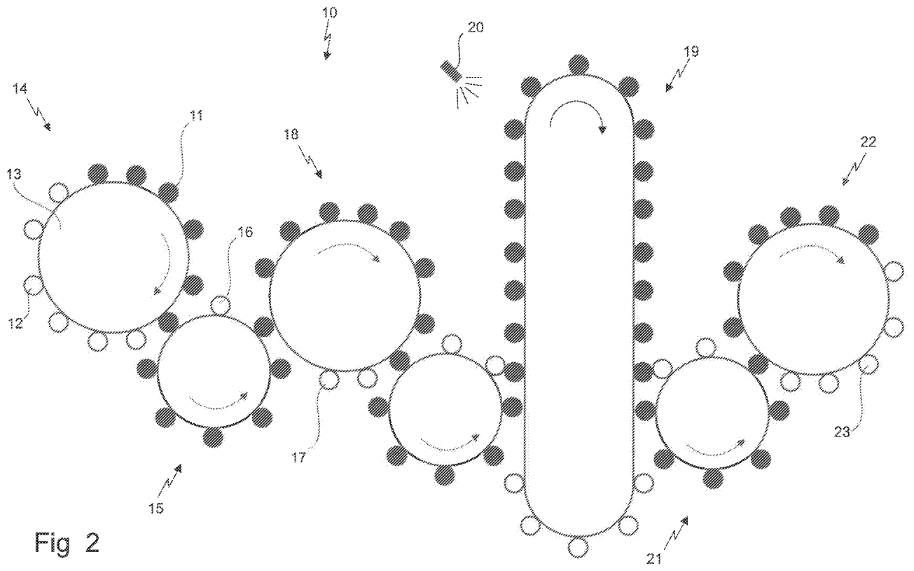

FIG. 2 shows a schematic representation of a device for ensuring an internal container pressure through application of pressure multiple times to the head space;

FIG. 1 shows a schematic representation of the method for ensuring an internal container pressure through application of pressure multiple times to the head space. For this purpose, it is provided that in a first method step 1 a plastic container is produced from a preform by a blow moulding process. This is then filled with a free-flowing medium, and, in particular with a liquid, in a second method step 2. Next it is provided that in a further method step 3 the medium contained in the head space of the filled plastic container is replaced by introduction of a replacement medium as a raised internal container pressure is produced. This could take place for example by the introduction of liquid nitrogen, which evaporates upon contact with the filing material and thus as gas displaces the medium previously contained in the head space of the filled plastic container medium from this head space. At the same time the use of liquid nitrogen has the advantage that the transition into the gaseous phase takes place on the contact surface with the filling material and thus a flow of nitrogen is formed which extends from there towards the mouth and which, likewise in this direction, displaces the medium previously contained in the head space.

Alternatively, however, it would also be conceivable that in a method step 2 a replacement medium is introduced into the plastic container and in a method step 3 the plastic container is filled with a flowable medium, and in particular with a liquid, so that the replacement medium contained in the plastic container is displaced as a raised internal container pressure is produced.

After the introduction of the replacement medium and of the flowable medium, in a subsequent step 4 the plastic container is at least partially closed.

In a subsequent step 5 it is provided in a variant of the method that in at least one portion of a wall of the plastic container surrounding the head space of the container, or a wall of the container closure or a wall of the plastic container at least one opening is introduced. This step 5 is not absolutely necessary, if it is ensured by different measures that an opening is present, through which in the subsequent step 6 the feeding in and/or discharge of a gaseous medium for setting of the predetermined internal container pressure is possible. This could for example take place by only partial closing of the container in step 4, so that between the container and the closure a channel remains, through which a gas replacement is possible.

In step 6 it is provided that, by the opening introduced in step 5 or the intermediate space existing between a mouth and the container closure (which in the context of this invention should likewise be understood as an opening) in the interior of the container, a predetermined internal container pressure is set by feeding and/or discharging a gaseous medium. This could be achieved for example in such a way that at least a portion of the container, which encloses the opening, is arranged in a chamber arranged in which the required internal container pressure prevails. Thus, the required internal container pressure can also be set in the interior of the container by the gas exchange via the opening. Alternatively, the active feeding in or discharge of the gaseous medium could also be provided, for example via a hollow needle used for producing the opening in step 5.

As a further alternative it would also be conceivable that, after the method steps 1-3, in a fourth method step 4 for setting a predetermined internal container pressure a gaseous medium is introduced into the plastic container, and in a fifth method step 5 the container is closed at least temporarily during the introduction of the gaseous medium. In this procedure there is no need for the method step 6. Potentially, however, a repeated, preferably partial opening of the closure could be provided, in order—for example after setting a target temperature of the filling material—to be able to set a required internal container pressure preferably permanently.

FIG. 2 shows a schematic representation of a device 10 for ensuring an internal container pressure through application of pressure multiple times to the head space. In this case FIG. 2 shows by way of example the variant of the method in which the plastic container is initially filled, then a replacement medium is introduced into the plastic container and the container is then closed.

The device 10 comprises a blow moulding device (not shown), which produces plastic containers 11 from preforms. These are fed to a filling device 14, where they are filled with a flowable medium, and in particular with a liquid. The filling material may be, in particular a beverage. This is preferably a filling material which is introduced while hot. The hot filling is advantageous in particular in the case of perishable or sterile filling materials, since in this way the contamination with heat-sensitive germs can be at least largely avoided and at least a certain sterility can be ensured. Therefore, it is possible and in many cases even advantageous if at least several of the processing devices 14, 18, 19, 22 of the device are arranged inside a clean room (not shown).

The filling device 14 is preferably a rotating filling device, which has along the circumference of a carrier wheel 13 a plurality of processing devices 12, in this case filling elements, through which the filling material can be introduced in each case into one of the containers 11.

Then the filled containers 11 are preferably transferred by means of a transfer device 15 to a replacement medium introduction device 18, which dispenses a replacement medium into the head space of the filled plastic container. The transfer device 15 is preferably designed as a transfer starwheel and preferably has holding devices 16, which preferably in each case can accommodate a container 11. At the same time the transfer device 15 also constitutes a transport device for transporting plastic containers 11 in a transport direction along a transport path. The transfer device 15 can be designed so that it changes the pitch of the containers, that is to say the spacing between two successive containers along the transport path.

In the illustrated embodiment the containers 11 are also transported to the respective processing devices 14, 18, 19, 22 during the individual processing steps, so that the processing devices 14, 18, 19, 22 themselves are also transport devices.

In the replacement medium introduction device 18 shown on the transport path downstream of the transfer device 15 in the transport direction the medium contained in the head space of the filled plastic container is replaced at least by introduction of a replacement medium as a raised internal container pressure is produced. For this purpose, at least one, preferably a plurality of replacement medium introduction devices 17 is arranged on the replacement medium introduction device 18. In the illustrated example the replacement medium introduction device 18 is also designed as a closer 18, so that on the same carrier wheel the plastic container is also closed at least partially by a container closure. The closing takes place in a sector of the circular segment-shaped transport path formed by the carrier wheel, which follows the sector in which the replacement medium is introduced into the filled plastic container.

In the present case the introduction of liquid nitrogen is provided. This evaporates upon contact with the filling material and because its volume increases multiple times in this case it drives the medium previously contained in the head space out of the container 11. Since the transition into the gaseous phase occurs primarily at the contact surface with the filling material, on the underside of the liquid nitrogen a gas cushion forms which acts as an isolation layer and delays the evaporation of the nitrogen. In this way it is ensured that for some time liquid nitrogen is available in the interior of the container. So long as there is still liquid nitrogen in the interior of the container, due to the progressive evaporation thereof a continuous gas stream is produced in the direction of the mouth, by which the medium previously contained in the head space is expelled and contamination of the filling material and of the interior of the container from the exterior is avoided. The closure is preferably applied to the container by the closer 18 during this phase.

The nitrogen which evaporates after this can no longer flow out unhindered through the mouth, so that a positive pressure is established in the interior of the container. In the event of only partial closing of the container the pressure can be reduced slowly through the remaining opening, but over a relatively long time period it remains above the ambient pressure, so that furthermore contamination due to the inflow of foreign substances from the exterior can be avoided.

The positive pressure remaining in the container 11 is necessary in order to avoid the penetration of germs during the subsequent temperature control in the temperature control device 19. Since during the cooling of the filling material the volume thereof usually decreases, it is possible to (over-)compensate for this decrease in volume by the positive pressure existing in the head space, so that overall the internal container pressure remains above the ambient pressure.

The temperature control device 19 preferably has at least one dispensing device 20 for a temperature control medium. A plurality of these dispensing devices 20 are preferably provided, which are arranged in the temperature control device 19 along the transport path and during the transport of the containers through the temperature control device 19 applies the temperature control medium to the containers. In a preferred embodiment the temperature control device 19 is a cooling device, which particularly preferably applies cooling water to the containers to be cooled. If heating of the containers is required (for example in order to bring them to a target temperature again after cooling) for example radiation such as IR and/or microwave radiation could be used as temperature control medium.

An internal container pressure setting device 22 is arranged on the transport path in the transport direction downstream of the closer 18 and in the present example also downstream of the temperature control device 19. After the at least partial closing and the temperature control the containers are fed by means of a transfer device 21 to the internal container pressure setting device 22. In this internal container pressure setting device 22 processing devices 23 are provided, which can grip and transport the container and furthermore during the transport through an opening can set a predetermined internal container pressure by feeding in and/or discharging a gaseous medium. For this purpose, a reservoir (not shown) of the gaseous medium can be provided, from which gas which is lacking or excessed gas is discharged into or fed from the head space of the container. For this purpose, the head space of the container and the reservoir are at least temporarily in fluid connection.

The at least one opening is arranged in a portion of a wall of the plastic container 11 surrounding the head space of the container or a wall of the container closure or is formed by an intermediate space existing between a mouth of the plastic container 11 and the container closure. The opening can be introduced for example by means of a penetration device (not shown). This could be part of the processing device 23 and thus of the internal container pressure setting device 22.

The applicant reserves the right to claim all the features disclosed in the application documents as essential to the invention in so far as they are individually or in combination novel over the prior art.

### LIST OF REFERENCES

1-6 method step
10 device
11 container
12 processing device
13 carrier wheel
14 filling device
15 transfer device
16 holding device
17 replacement medium introduction unit
18 replacement medium introduction device, closer
19 temperature control device
20 dispensing device
21 transfer device
22 internal container pressure setting device
23 processing device

1: A method for filling and closing a thin-walled plastic container, in particular a PET bottle, wherein a plastic container is produced from a preform by a blow moulding process, and the plastic container is filled with a flowable medium and in particular a liquid, and also a replacement medium is introduced into the plastic container so that as the internal container pressure increases at least partial displacement of the previously contained medium takes place and the plastic container is at least partially closed, wherein in at least one portion of a wall of the plastic container surrounding a head space of the plastic container or a wall of the container closure at least one opening is introduced, and through this opening in the interior space of the plastic container a predetermined internal container pressure is set by feeding in and/or discharging a gaseous medium.

2: The method according to claim 1, wherein the replacement medium is nitrogen, preferably liquid nitrogen.

3: The method according to claim 2, wherein the production of the raised internal container pressure takes place by an increase in volume of the nitrogen during the transition from the liquid phase into the gaseous phase.

4: The method according to claim 2, wherein the flowable medium has a temperature above an ambient temperature, preferably in the range from 40-110° C., more preferably in the range from 50-100° C., particularly preferably in the range from 60-90° C.

5: The method according to claim 4, wherein during and/or after a process, preferably an active cooling of the filling material, the setting of the predetermined internal container pressure takes place by feeding in and/or discharging the gaseous medium.

6: The method according to claim 4, wherein an internal container pressure is set which is in the range from 1.05-7 bars, preferably 1.1-5 bars, more preferably 1.2-3 bars, particularly preferably 1.25-2 bars above the ambient pressure.

7: The method according to claim 1, wherein the opening is closed after the setting of an internal container pressure by feeding in and/or discharge of a gaseous medium.

8: A device for filling and closing a thin-walled plastic container, in particular a PET bottle, comprising a blow moulding device for producing a plastic container from a preform, a filling device for filling the plastic container with a flowable !medium, and in particular with a liquid; a closer for at least partially closing the plastic container with a container closure and at least one transport device for transporting the plastic container in a transport direction on a transport path from one of the above-mentioned processing devices to a subsequent processing device downstream, wherein on the transport path in the transport direction downstream and/or upstream of the filling device a replacement medium introduction device is arranged, by which a replacement medium can be introduced into the plastic container, wherein as a raised internal container pressure is produced the previously contained medium can be at least partially displaced, and on the transport path in the transport direction downwards of the closer a device is arranged by which an opening can be introduced in at least one portion of a wall of the plastic container surrounding a head space of the plastic container or a wall of the container closure, and wherein through this opening a predetermined internal container pressure can be set by feeding in and/or discharging a gaseous medium.

9: The device according to claim 8, wherein the replacement medium introduction device is fluidically connected to a nitrogen reservoir from which nitrogen, preferably liquid nitrogen, can be dispensed and can be metered into the plastic container.

10: The device according to claim 8, wherein the internal container pressure setting device has at least one valve which can be fluidically connected via the opening to the head space of the filled plastic container at least temporarily, is preferably regulable, and by which an internal pressure of the plastic container can be preselected.

11: The device according to claim 8, wherein on the transport path in the transport direction downstream and/or upstream of the replacement medium introduction device and upstream of the internal container pressure setting device a temperature control device, preferably a cooling device, is arranged, by means-of which the plastic container, preferably including the contained flowable medium, can be brought to a target temperature in the range from 4-70° C., preferably 10-50° C.

12: The device according to claim 8, wherein the device has a closing device configured for closing the produced opening, in particular after setting of the internal container pressure has taken place by feeding in or discharging a gaseous medium.

13: The device according to claim 9, wherein the internal container pressure setting device has at least one valve which can be fluidically connected via the opening to the head space of the filled plastic container at least temporarily, is preferably regulable, and by which an internal pressure of the plastic container can be preselected.

14: The device according to claim 9, wherein on the transport path in the transport direction downstream and/or upstream of the replacement medium introduction device and upstream of the internal container pressure setting device a temperature control device, preferably a cooling device, is arranged, by which the plastic container, preferably including the contained flowable medium, can be brought to a target temperature in the range from 4-70° C., preferably 10-50° C.

15: The device according to claim 9, wherein the device has a closing device configured for closing the produced opening, in particular after setting of the internal container pressure has taken place by feeding in or discharging a gaseous medium.

16: The device according to claim 10, wherein on the transport path in the transport direction downstream and/or upstream of the replacement medium introduction device and upstream of the internal container pressure setting device a temperature control device, preferably a cooling device, is arranged, by which the plastic container, preferably including the contained flowable medium, can be brought to a target temperature in the range from 4-70° C., preferably 10-50° C.

17: The device according to claim 10, wherein the device has a closing device configured for closing the produced opening, in particular after setting of the internal container pressure has taken place by feeding in or discharging a gaseous medium.

18: The device according to claim 11, wherein the device has a closing device configured for closing the produced opening, in particular after setting of the internal container pressure has taken place by feeding in or discharging a gaseous medium.
